(19) United States
(12) Patent Application Publication
(10) Pub. No.: US 2025/0033120 A1
(43) Pub. Date: Jan. 30, 2025

(54) POWDER SUPPLY SYSTEM AND THREE-DIMENSIONAL PRINTER EMPLOYING SYSTEM

(71) Applicant: HON HAI PRECISION INDUSTRY CO., LTD., New Taipei (TW)

(72) Inventors: SZU-HAI HUANG, New Taipei (TW); CHING-JU KUO, New Taipei (TW)

(21) Appl. No.: 18/738,005

(22) Filed: Jun. 8, 2024

(30) Foreign Application Priority Data
Jul. 27, 2023 (CN) 202310936096.1

(51) Int. Cl. B22F 12/52; B22F 12/00; B22F 12/57; B22F 12/63; B33Y 30/00

(52) U.S. Cl. CPC B22F 12/52; B22F 12/226; B22F 12/57; B22F 12/63; B33Y 30/00

(57) ABSTRACT

A powder supply system for supplying powders by a transmission structure includes a first stock bin, a driven member, a driving medium, and a second stock bin. The first stock bin includes an outlet, the driven member is arranged at the outlet, and the driven member includes a powder holding area configured for receiving the powders discharged from the outlet. The outlet is arranged opposite to an inlet of the second stock bin, the second stock bin can drive the driving medium to contact the driven member when moving to a discharge range corresponding to the outlet, and the driven member can discharge the powders in the powder holding area into the second stock bin by the driving medium driving the driven member. A three-dimensional printer is also disclosed.

### TECHNICAL FIELD

The subject matter herein generally relates to powders supplying.

### BACKGROUND

A powder supply system of the current three-dimensional printer may includes a powder storage component for storing powders, a powder distributing component for extracting the powders from the powder storage unit, and a powder spread component for tiling the powders, etc., each component is equipped with a power source for driving. For example, a power source corresponding to the powder distributing component may control a movement of the powder distributing component to achieve a control of powder supply, and a power source corresponding to the powder spread component may control a movement of the powder spread component to tile the powders on a platform of the three-dimensional printer.

However, the power source is expensive. If each component is equipped with a power source, a cost of the powder supply system is higher.

### BRIEF DESCRIPTION OF THE DRAWINGS

Implementations of the present disclosure will now be described, by way of embodiments, with reference to the attached figures.

FIG. 1 is a structure diagram illustrating an upper powder supply system in the prior art.

FIG. 2 is a first stereo structure diagram illustrating a powder supply system according to an embodiment of the present disclosure.

FIG. 3 is a structure diagram illustrating a first stock bin according to an embodiment of the present disclosure.

FIG. 4 is a structure diagram illustrating the powder supply system including a powder supply control device according to an embodiment of the present disclosure.

FIG. 5 is a planar structure diagram illustrating the powder supply system according to an embodiment of the present disclosure.

FIG. 6 is a second stereo structure diagram illustrating the powder supply system according to an embodiment of the present disclosure.

FIG. 7 is a structure diagram illustrating a second stock bin according to an embodiment of the present disclosure.

FIG. 8 is a structure diagram illustrating a moving process of the second stock bin for feeding powders according to an embodiment of the present disclosure.

FIG. 9 is a structure diagram illustrating a roller rotation of the second stock bin in the feeding process according to an embodiment of the present disclosure.

FIG. 10 is a planar structure diagram illustrating the powder supply system according to another embodiment of the present disclosure.

FIG. 11 is a structure diagram illustrating a pushing member enters an inner cavity of a powder holding box according to an embodiment of the present disclosure.

FIG. 12 is a structure diagram illustrating a limiting member according to an embodiment of the present disclosure.

FIG. 13 is a structure diagram illustrating a 3D printer according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “connected” is defined as directly or indirectly through intervening components. The connection can be such that the objects are permanently connected or releasably connected. The term “comprising,” when utilized, means “including, but not necessarily limited to”; it specifically indicates open-ended inclusion or membership in the so-described combination, group, series, and the like.

In a three-dimensional (3D) manufacturing method, a 3D printer can form a powder layer of a certain thickness to spray glue and superimpose to generate 3D shapes. To improve a manufacturing accuracy of a 3D product, a thickness of the powder layer need to be precisely controlled and compress the powder layer evenly on a platform.

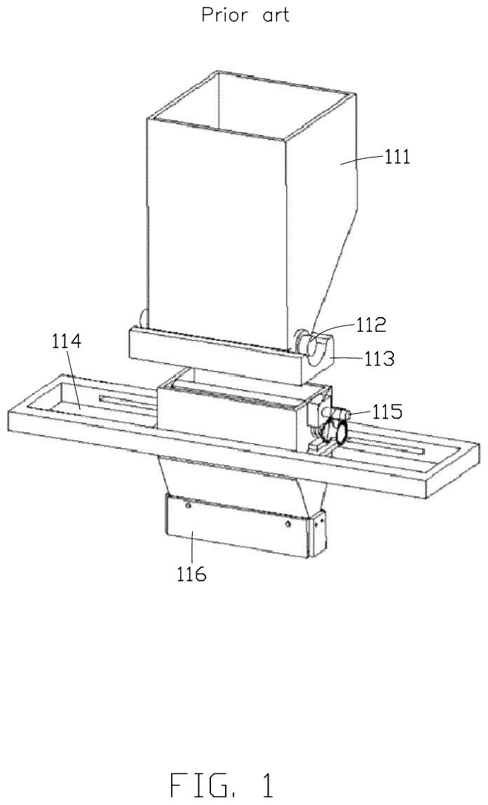

As shown in FIG. 1, illustrating one exemplary embodiment of an upper powder supply system of a 3D printer. The upper powder supply system includes an upper module and a lower module. The upper module includes a powder storage unit 111 (also may know as a hopper) for storing powders, a powder distributing component 112 (also may know as a powder metering component) for extracting powders from the powder storage unit 111, and a baffle plate 113, etc.

The lower module may includes a powder spreader 114 (also may know as a mobile coater) for tiling the powders, a metering vibrating component 115, and a powder outlet 116.

The upper powder supply system is equipped with multiple power sources. For example, a power source corresponding to the powder distributing component 112 may control a movement of the powder distributing component 112 to achieve a control of powder supply, and a power source corresponding to the powder spreader 114 may control a movement of the powder spreader 114 to tile the powders.

However, the power source is expensive, and a cost of the upper powder supply system is higher.

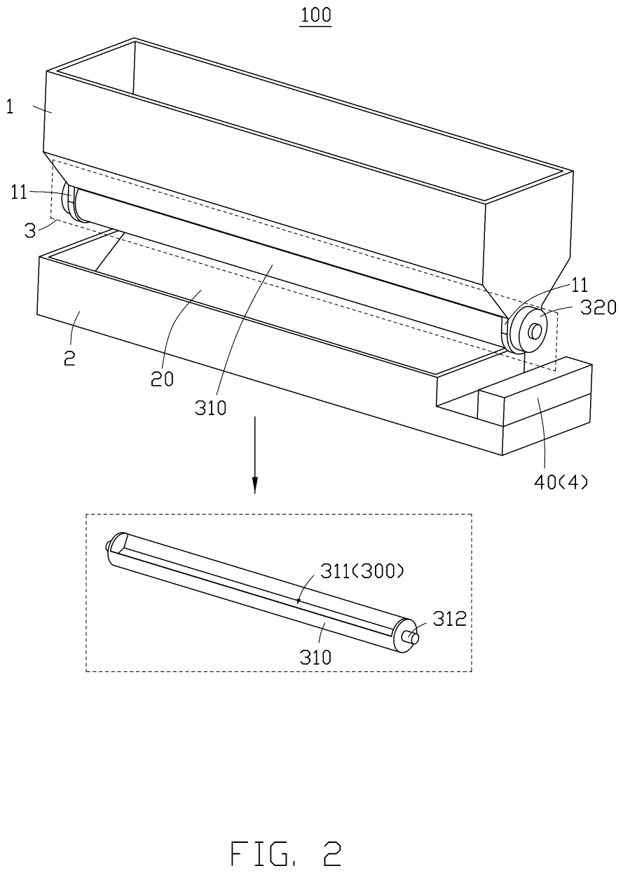

As shown in FIG. 2 to FIG. 10, illustrating one exemplary embodiment of a powder supply system 100 with a lower cost.

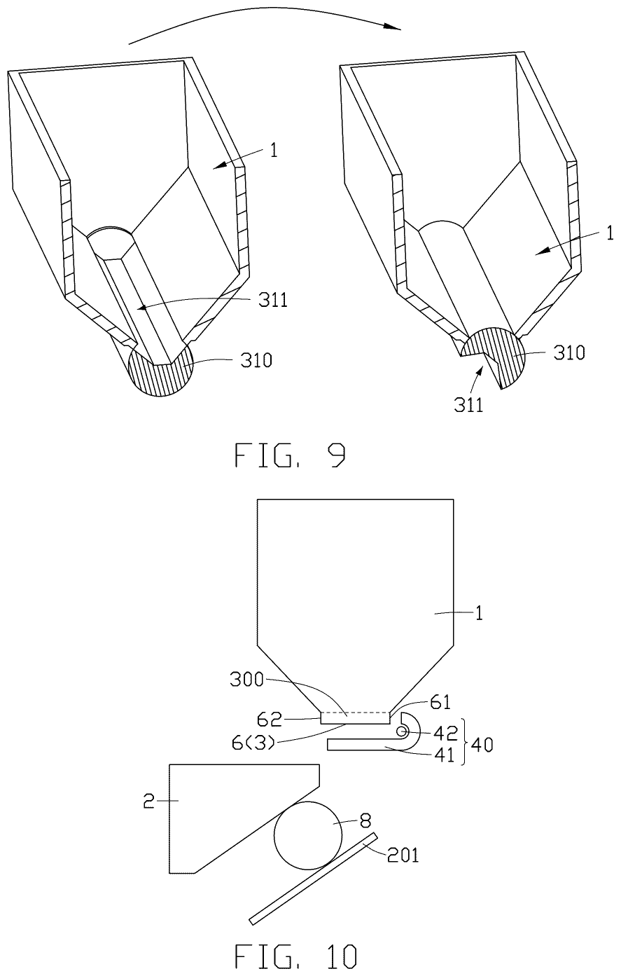

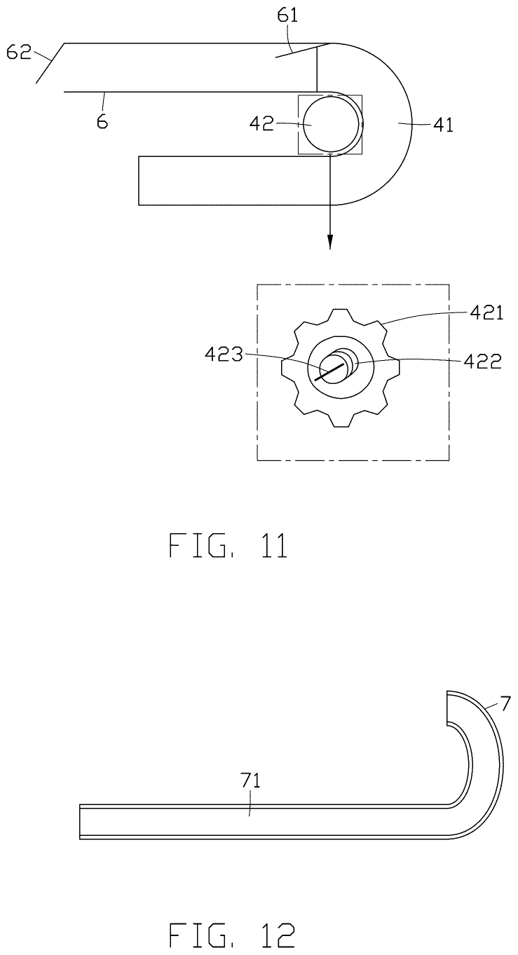

Referring to FIG. 2 and FIG. 10, the powder supply system 100 includes a first stock bin 1, a second stock bin 2, a driven member 3, and a driving medium 4.

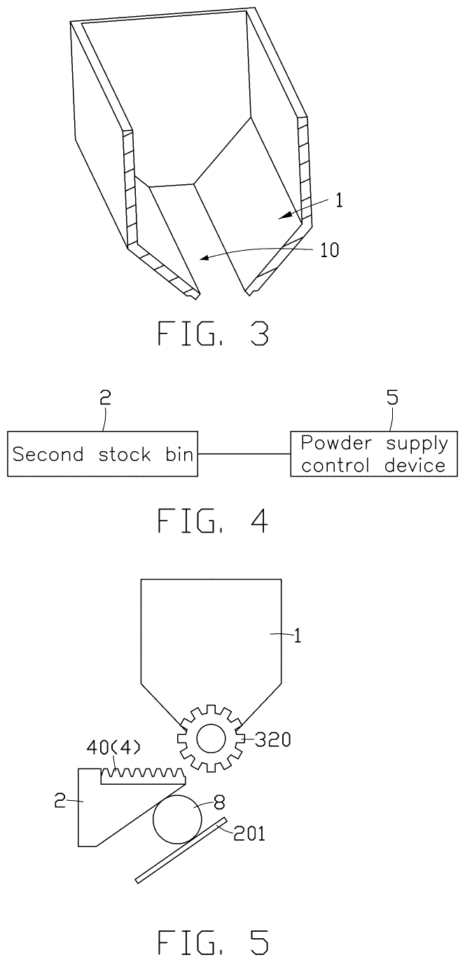

Referring to FIG. 3, the first stock bin 1 is configured to store powders, the first stock bin 1 includes a first outlet 10. The second stock bin 2 includes an inlet 20. The inlet 20 of the second stock bin 2 is arranged opposite to the first outlet 10 of the first stock bin 1.

The driven member 3 is arranged at the first outlet 10 of the first stock bin 1, and the driven member 3 includes a powder holding area 300. The powder holding area 300 is configured for receiving the powders discharged from the first outlet 10 of the first stock bin 1. The driven member 3 is drivingly connected with the driving medium 4.

The second stock bin 2 is configured to drive the driving medium 4 to contact the driven member 3 when the second stock bin 2 is moved to a discharge range corresponding to the first outlet 10 of the first stock bin 1, and the driving medium 4 driving the driven member 3 to discharge the powders in the powder holding area 300 into the second stock bin 2.

In one embodiment, a volume of the powder holding area 300 is a fixed value, and the powders can be quantitatively obtained from the first stock bin 1 by the powder holding area 300, so that in a single movement process of the driven member 3, a quantitative of powder is discharged to the second stock bin 2, and a quantitative supplying of powder is realized, and a powder supply amount and a powder residual are conveniently to count.

In one embodiment, the powder supply system 100 can be applied to a 3D printer, and can also be applied to other devices that need to supply powders, and the embodiments does not limit an application range of the powder supply system 100.

The powder supply system 100 of the embodiments is provided with the driven member 3 and the driving medium 4, the second stock bin 2 can drive the driven member 3 to move through the driving medium 4, and the powder holding area 300 arranged in the driven member 3 can achieve powder feeding. A collaborative of each component of the powder supply system 100 is realized through a mechanical transmission, usage requirements of power sources, such as motors, cylinders, are omitted, a powder supply efficiency of the powder supply system 100 is guaranteed. A cost of the mechanical transmission is lower than a cost of the power source, therefore, a powder supply cost of the powder supply system 100 is also reduced.

Referring to FIG. 4, the powder supply system 100 further includes a powder supply control device 5. The powder supply control device 5 is communicated with the second stock bin 2, and the powder supply system 100 can achieve a precise control of powder supply through the powder supply control device 5.

In one embodiment, the powder supply control device 5 can be worked as a power source of the second stock bin 2 to control the movement of the second stock bin 2. The second stock bin 2 can also be provided with a displacement sensor, a pressure sensor, and other detection sensors, and the powder supply control device 5 can be connected to the detection sensors of the second stock bin 2 through circuit wirings, and a moving distance and/or a moving direction of the second stock bin 2 can be controlled according to detection signals of the detection sensors.

The communication connection way between the powder supply control equipment 5 and the detection sensor can be set according to actual requirements, and the embodiments does not limit this.

In one embodiment, the powder supply control device 5 can obtain information of powder supply demands, and control the second stock bin 2 to move based on the information of the powder supply demands. For example, the powder supply system 100 is applied in the 3D printer, the powder supply demands can be determined based on an area of each slice of a 3D model to be printed.

In one embodiment, the powder supply control device 5 controlling the second stock bin 2 to move based on the information of the powder supply demands may includes: obtaining a mapping relationship between a motion amount of the driven member 3 and a powder feeding amount of the powder holding area 300 arranged in the driven member 3; determining a total amount of motion of the driven member 3 to meet the powder supply demands based on the mapping relationship; determining a motion strategy of the second stock bin 2 based on the total amount of motion of the driven member 3; and controlling the second stock bin 2 to move based on the motion strategy of the second stock bin 2.

In one embodiment, the mapping relationship between the motion amount of the driven member 3 and the powder feeding amount of the powder holding area 300 arranged in the driven member 3 can be determined according to a motion mode of the driven member 3 and a size of the powder holding area 300, and the embodiments do not limit this.

For example, the mapping relationship includes: the driven member 3 moving x1 mm (millimeter), and corresponding powder feeding amount being y1 gram; or the driven member 3 rotating x2 degree, and corresponding powder feeding amount being y2 gram.

In the above step, to achieve determining the motion strategy of the second stock bin 2 based on the total amount of motion of the driven member 3, structure types of the driven member 3 and the driving medium 4 need to be considered. For example, there is also an objective mapping relationship between the amount of motion of the driven member 3 and the amount of motion of the second stock bin 2. For example, the objective mapping relationship includes: the second stock bin 2 driving the driving medium 4 to move x3 mm, and a displacement of the driven member 3 being x3 mm; or the second stock bin 2 driving the driving medium 4 to move x4 mm, a rotating degree of the driven member 3 being y4 degree.

In one embodiment, the powder supply control device 5 may further obtain the current motion information of the second stock bin 2, and determine the current powder supply amount of the powder supply system 100 according to the current motion information of the second stock bin 2.

For example, the powder supply control device 5 determining the current powder supply amount of the powder supply system 100 according to the current motion information of the second stock bin 2 may includes: the powder supply control device 5 determining the current motion information of the driven member 3 according to current motion information of the second stock bin 2; the powder supply control device 5 obtaining information of a total powder holding amount of the powder holding area 300, and determining the current powder supply amount of the powder supply system 100 according to the current motion information of the driven member 3 and the information of the total powder holding amount of the powder holding area 300. For example, the powder supply control device 5 determines the powder supply amount of the powder supply system 100 in the current powder feeding process according to the current motion information of the driven member 3 and the information of the total powder holding amount of the powder holding area 300.

For example, the current motion information of the second stock bin 2 may includes the current motion trajectory of the second stock bin 2 in the current powder supply process, and the current motion trajectory may indicate the amount of motion of the driven member 3.

For example, if the total powder holding amount of the powder holding area 300 is m grams, the second feed bin 2 is determined to push the driven member 3 to discharge all the powder of the powder holding area 300 twice into the second stock bin 2 based on the motion trajectory of the second stock bin 2, therefore, the current powder supply amount of the powder supply system 100 is 2*m grams.

With the difference of the structure of the driven member 3 and the driving medium 4, the mapping relationship between the motion amount of the driven member 3 and the powder feeding amount of the powder holding area 300 arranged in the driven member 3 is different, the mapping relationship between the motion amount of the second stock bin 2 and the motion amount of the driven member 3 is also different. The following embodiments combine the structures of the driven member 3 and the driving medium 4, to illustrate the powder feeding process of the powder supply system 100, the structures of the driven member 3 and the driving medium 4 are not limited in the following embodiments.

Referring to FIG. 2 and FIG. 5, the driven member 3 may includes a gear 320, the driving medium 4 may include a driving rack 40, and the gear 320 and the driving rack 40 can be meshed and linked.

In one embodiment, the driven member 3 may includes the gear 320 and a roller 310. The gear 320 are coaxially connected with the roller 310, and the powder holding area 300 can be arranged at the roller 310.

Referring to FIG. again, the roller 310 can be a long axis shape, or other shapes. At least one groove 311 is arranged at the roller 310, and the groove 311 can be used as the powder holding area 300. A side outer wall of the roller 310 and an sidewall of the inner cavity of the outlet of the first stock bin 1 are rotatably sealed. An opening width of the powder holding area 300 is not greater than an opening width of the outlet of the first stock bin 1. That is, an opening width of the groove 311 is not greater than an opening width of the first outlet 10 of the first stock bin 1, so that when the groove 311 corresponds to the first outlet 10 of the first stock bin 1, side outer walls of the rollers 310 on both sides of the groove 311 can keep rotation sealing with the first outlet 10, to avoid powder leaking out from a connection position between the roller 310 and the first outlet 10. The roller 310 is arranged at the first outlet 10 of the first stock bin 1, and the roller 310 can rotatably block the first outlet 10 of the first stock bin 1, which can avoid the powders from falling out of a gap between the first stock bin 1 and the roller 310, improving the accuracy of powder supply.

In one embodiment, along an axial direction of the roller 310, two ends of the first outlet 10 of the first stock bin 1 are provided with installation portions 11, and two ends of the roller 310 are respectively rotatably connected to two installation portions 11. An axis of at least one end of the roller 310 is also provided with a gear connection portion 312, the roller 310 and the gear 320 are coaxially connected through the gear connection portion 312.

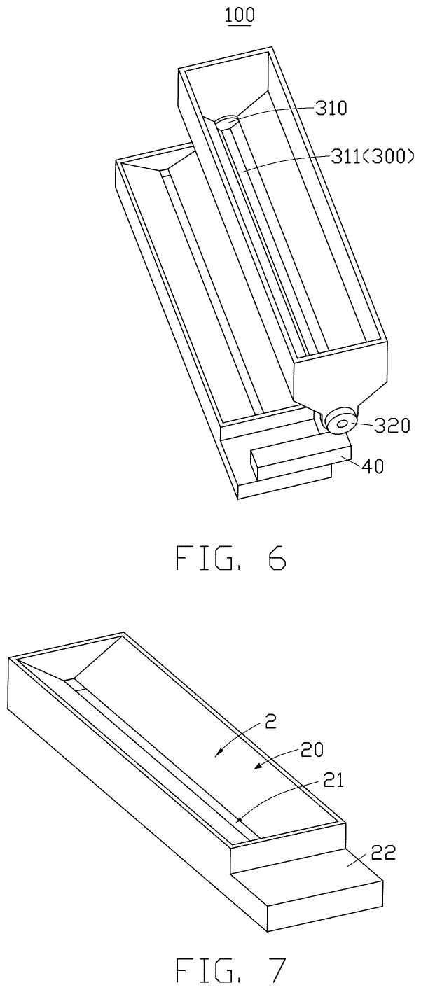

Referring to FIG. 6, illustrating one exemplary embodiment of a structure of the powder supply system in another angle. The roller 310 can span the first outlet 10 of the first stock bin 1, to receive the powders discharged from the first outlet 10 of the first stock bin 1. Because the roller 310 and the gear 320 are coaxially connected, the gear 320 can drive the roller 310 to roll when rotating, so that a position of the groove 311 relative to the first outlet 10 of the first stock bin 1 can be changed.

Referring to FIG. 5 again, the driving medium 4 of the powder supply system 100 can be the driving rack 40, and the driving rack 40 is arranged at the second stock bin 2, and corresponded to the gear 320.

In one embodiment, the structure of the second stock bin 2 can be shown in FIG. 7, a bottom of the second stock bin 2 is provided with a second outlet 21, and a structure of the second outlet 21 can be a strip hole shape, so that the powders can be evenly and smoothly discharged from the second outlet 21 of the second stock bin 2, and the powders can be evenly tiled on the platform 201 (as shown in FIG. 5 or FIG. 10) of the 3D printer.

In one embodiment, an edge of the second stock bin 2 can also be provided with a rack mounting position 22, to install the driving rack 40.

The driving rack 40 is configured to mesh and link with the gear 320 to drive the roller 310 to roll when the second stock bin 2 moves to the discharge range corresponding to the first outlet 10 of the first stock bin 1, so that a discharge port of the powder holding area 300 (i.e., groove 311) arranged on the roller 310 moves out of the first outlet 10 of the first stock bin 1, and the powders in the powder holding area 300 is poured to the inlet 20 of the second stock bin 2.

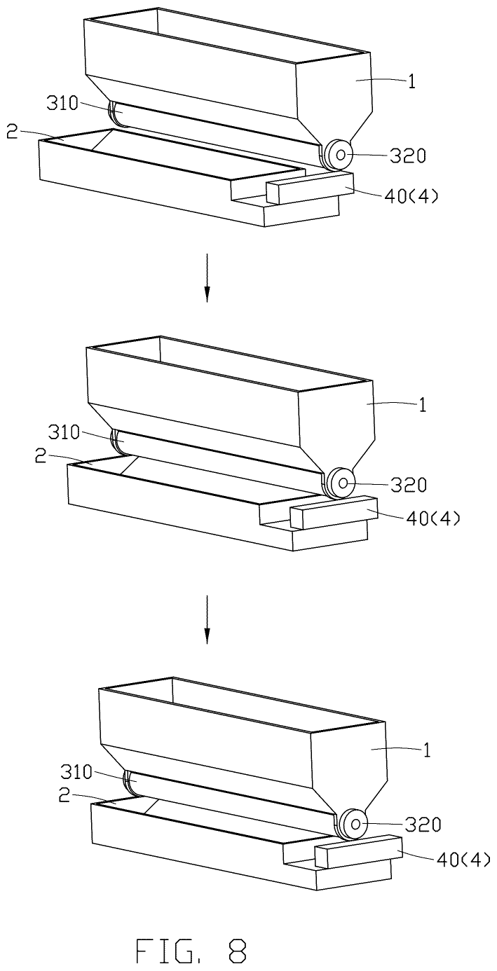

Referring to FIG. 8 and FIG. 9, FIG. 8 is a diagram of a moving process for feeding powders of the second stock bin 2, FIG. 9 is a diagram of a roller rotation of the second stock bin 2 in the feeding process, and the feeding process of the second stock bin 2 is described by combining FIG. 8 and FIG. 9.

Step 1, the second stock bin 2 moves towards a bottom of the first stock bin 1, and the gear 320 and the driving rack 40 are ready to be meshed. As the view of FIG. 8, the second stock bin 2 moves from left to right.

Step 2, the second stock bin 2 continues to move, and the gear 320 is meshed with the driving rack 40, and the roller 310 is drove to roll. As the view of FIG. 8, a rolling direction of the roller 310 is counterclockwise.

Referring to FIG. 9, in a rolling process of the roller 310, the groove 311 of the roller 310 will rotate out of the first outlet 10 from the position of facing the first outlet 10 of the first stock bin 1. When the groove 311 is facing the first outlet 10, the powders of the first stock bin 1 falls into the groove 311. After the roller 310 continuously rolls along the counterclockwise direction, the groove 311 carries the powders to rotate out of the first outlet 10.

Step 3, the second stock bin 2 stops moving, the roller 310 rotates nearly half-turn, the groove 311 obtains the powders from the first stock bin 1 and rotates out of the first outlet 10, and the powders of the groove 311 (i.e., the powder holding area 300) of the roller 310 is all poured into the second stock bin 2.

In one embodiment, when the second stock bin 2 is reset along a direction from right to left, the gear 320 can be driven to rotate clockwise through the driving rack 40, and the groove 311 of the roller 310 can be return to the position corresponding to the first outlet 10 (i.e., the position facing to the first outlet 10), the groove 311 can receive the powders again, and wait for the next powder feeding.

Alternatively, the second stock bin 2 can continue to move from left to right, and drive the roller 310 to continue rolling in the counterclockwise direction, so that the groove 311 of the roller 310 is again facing the first outlet 10 of the first stock bin 1, to wait for the next powder feeding.

In one embodiment, the second stock bin 2 of the powder supply system 100 can be communicated with the powder supply control device 5.

In the powder supply system 100, if the total powder holding amount of the powder holding area 300 is m grams, the mapping relationship between the motion amount of the driven member 3 and the powder feeding amount of the powder holding area 300 arranged in the driven member 3 can be: in the rotation process of the roller 310, the powder feeding amount is m grams after the groove 311 passing through the first outlet 10 of the first stock bin 1 and the inlet 20 of the second stock bin 2 every time.

For example, one groove 311 is arranged at the roller 310, when a starting position of the groove 311 is facing the first outlet 10 of the first stock bin 1, the roller 310 rotates 180 degrees, and the powder feeding amount is m grams.

If the powder supply demands is 3 m grams, the powder supply control device 5 can divide the powder supply demands by the total powder holding amount of the powder holding area 300, to determine that the groove 311 needs to pass through the first outlet 10 of the first stock bin 1 three times, and pass through the inlet 20 of the second stock bin 2 three times. Then, the powder supply control device 5 can drive the second stock bin 2 to drive the driving rack 40, and the driving rack 40 is meshed and linked with the gear 320, so that the gear 320 is rotated, and the groove 311 passes through the first outlet 10 of the first stock bin 1 three times, and passes through the inlet 20 of the second stock bin 2 three times.

The powder supply control device 5 can control the second stock bin 2 to move based on the information of the powder supply demands, to realize a precise control of the powder supply.

In the motion process of the second stock bin 2, the powder supply control device 5 can also obtain the current motion information of the second stock bin 2, to obtain the current powder supply amount. For example, the second stock bin 2 drives the roller 310 to rotate two turns, and the current powder supply amount is 2 m grams.

In one embodiment, the powder supply system 100 can realize a transmission drive by a meshing linkage between the gear 320 and the driving rack 40. In other embodiments, the powder supply system 100 can realize the transmission drive by a pushing member.

Referring to FIG. 10, illustrating another exemplary embodiment of the powder supply system 100.

The driven member 3 includes a powder holding box 6, the powder holding area 300 is arranged in an inner cavity of the powder holding box 6. The powder holding box 6 further includes a first movable sidewall 61 and a second movable sidewall 62, and the first movable sidewall 61 is arranged opposite to the second movable sidewall 62.

The driving medium 4 includes a pushing member 41, a first end of the pushing member 41 is arranged opposite to the first movable sidewall 61, a second end of the pushing member 41 is correspondingly arranged to the second stock bin 2. The pushing member 41 is configured to push the first movable sidewall 61 to move within the inner cavity of the powder holding box 6, and powders in the inner cavity of the powder holding box 6 is driven by the first movable sidewall 61, the second movable sidewall 62 is pushed to move exterior the inner cavity of the powder holding box 6 when the powders in the inner cavity of the powder holding box 6 is pushed to move by the first movable sidewall 61.

In one embodiment, referring to FIG. 11, when the pushing member 41 enters the inner cavity of the powder holding box 6, the pushing member 41 is in contact with the inner wall of the powder holding box 6, powders between the outer wall of the pushing member 41 and the inner wall of the powder holding box 6 can be reduced, the displacement of the pushing member 41 in the powder holding box 6 can accurately indicate the powder supply amount, and improving the accuracy of the powder supply amount calculation.

The second stock bin 2 is further configured to contact the second end of the pushing member 41 to drive the pushing member 41 to mov when the second stock bin 2 moves to the discharge range corresponding to the first outlet 10 of the first stock bin 1.

In one embodiments, referring to FIG. 12, the powder supply system 100 may further include a limiting member 7, the limiting member 7 can be arranged at the motion path of the pushing member 41, the limiting member 7 is slidably connected with the pushing member 41, and the limiting member 7 is configured to limit a movement of the pushing member 41 within a fixed path (i.e., the motion path of the pushing member 41).

In one embodiment, the limiting member 7 may include a limiting groove 71, a shape of the limiting groove 71 matches with the motion path of the pushing member 41, and the pushing member 41 can slide in the limiting groove 71, so when the second stock bin 2 pushes the second end of the pushing member 41, the pushing member 41 can move along the limiting groove 71, the first end of the pushing member 41 pushes the first movable sidewall 61 to move within the inner cavity of the powder holding box 6.

The limiting member 7 with limiting groove 71 is just an example, and in a actual application, it can be set and replaced. For example, the limiting member 7 may include a plurality of limiting blocks, and the pushing member 41 can move within the fixed path by the plurality of limiting blocks.

In one embodiment, when the second stock bin 2 is disengaged from contact with the second end of the pushing member 41, for example, the second stock bin 2 leaves away from the pushing member 41 (is not at the pushing member 41), the pushing member 41 can be automatically reset.

For example, after the second stock bin 2 is not at the pushing member 41, the second stock bin 2 cannot provide a power of motion for the pushing member 41, and the pushing member 41 can slip to the initial position along the limiting groove 71 under an action of gravity.

For example, the pushing member 41 can be reset by using a reset member 42.

In one embodiment, the driving medium 4 further includes the reset member 42, the reset member 42 is connected with the pushing member 41, and the reset member 42 is configured to restore a position of the pushing member 41 when the second stock bin 2 is not at the second end of the pushing member 41.

In one embodiment, referring to FIG. 11 again, the reset member 42 may include a reset gear 421 meshed with the pushing member 41, a torsion spring 422 for driving the reset gear 421 to reset, and a rotating shaft 423 for installing the reset gear 421 and the torsion spring 422. The rotating shaft 423 may be fixedly connected with an external frame or a mounting base to locate the position of the reset gear 421.

In one embodiment, a spring body of the torsion spring 422 is co-axial with the reset gear 421, and the spring body of the torsion spring 422 can be sleeved on the rotating shaft 423, an end of the torsion spring 422 is fixed on the rotating shaft 423, an other end of the torsion spring 422 is fixed on the reset gear 421, and the reset gear 421 is meshed and linked with the pushing member 41. For example, one side of the pushing member 41 close to the reset gear 421 includes a tooth shape consistent with the reset gear 421, so that the reset gear 421 can be meshed and linked with the pushing member 41.

When the second stock bin 2 pushes the pushing member 41 to move, the pushing member 41 is meshed with the reset gear 421, the reset gear 421 drives one end connected with the torsion spring 422 to rotate, so that the torsion spring 422 is deformed. After the second stock bin 2 is not at the pushing member 41, the second stock bin 2 cannot provide power for the pushing member 41, at this time, the torsion spring 422 can be restored to the original state. When the torsion spring 422 is restored to the original state, the torsion spring 422 can provide an elasticity to the reset gear 421, to drive the reset gear 421 to rotate and reset, the reset gear 421 is meshed with the pushing member 41, and the pushing member 41 is driven to move, so that the pushing member 41 can be reset.

The above structure of the reset member 42 is only an example, for example, the reset member 42 may also only include the torsion spring 422, one end of the torsion spring 422 is fixed, and the other end of the torsion spring 422 is directly connected with the pushing member 41. The structure of the reset member 42 can be set according to the actual application, and the embodiments do not limit the structure of the reset member 42.

Furthermore, in a process of automatic reset of the pushing member 41, the first movable sidewall 61 and the second movable sidewall 62 may also be gradually reset. For example, the first movable sidewall 61 and the second movable sidewall 62 return to their original positions under the action of gravity.

In the process of automatic reset of the pushing member 41, the pushing member 41 may gradually leave the inner cavity of the powder holding box 6, the pushing member 41 cannot provide a power for the powders in the inner cavity to open the second movable sidewall 62, so that the second movable sidewall 62 can be automatically reset. After the pushing member 41 is not at the powder holding box 6, the pushing member 41 cannot contact with the first movable sidewall 61, so that the first movable sidewall 61 can also be automatically reset.

In one embodiments, the powder supply system 100 may further include the powder supply control device 5, the powder supply control device 5 is communicated with the second stock bin 2, the powder supply control device 5 is configured to obtain the information of the powder supply demands, and control the second stock bin 2 to move based on the information of the powder supply demands.

For example, the powder supply control device 5 can obtain the powder supply amount corresponding to a movement of the pushing member 41 every 1 mm in the inner cavity of the powder holding box 6, divide the powder supply demands by the powder supply amount corresponding to the movement of 1 mm in the inner cavity of the powder holding box 6, the total distance of the pushing member 41 that needs to push the powder movement can be obtained, and the motion trajectory of the second stock bin 2 can be determined based on the total distance that the pushing member 41 needs to push the powder movement, and the second stock bin 2 can be controlled to move based on the motion trajectory of the second stock bin 2.

For example, the pushing member 41 move every 1 mm in the inner cavity of the powder holding box 6 to push the powder to move, the powder supply amount is y milligrams, the total length of the powder holding box 6 is x millimeters, and the total powder holding amount of the powder c holding box 6 is x*y milligram.

If the powder supply demands is 40y milligrams, and the total length of the powder holding box 6 is greater than 40 millimeters, the pushing member 41 needs to push the powder to move 40 millimeters, and the powder supply control device 5 can control the second stock bin 2 to push the pushing member 41 to move 40 millimeters within the inner cavity of the powder holding box 6, and then leave the pushing member 41.

If the powder supply demands is 2xy milligrams, the pushing member 41 needs to push the powder to move 2x mm, the powder supply control device 5 can control the second stock bin 2 to push the pushing member 41 to move x millimeter within the inner cavity of the powder holding box 6, then control the second stock bin 2 to leave the pushing member 41. After the pushing member 41 is reset, the powder supply control device 5 can control the second stock bin 2 to push the pushing member 41 to move x millimeter within the inner cavity of the powder holding box 6 again, then control the second stock bin 2 to leave the pushing member 41.

The powder supply control device 5 may further obtain the information of the total powder holding amount of the powder holding area 300, determine the current motion information of the driven member 3 according to the current motion information of the second stock bin 2, and determine the current powder supply amount of the powder supply system 100 according to the current motion information of the driven member 3 and the information of the total powder holding amount of the powder holding area 300.

For example, the second stock bin 2 pushes the push member 41 to move 2.5x mm, and the current powder supply amount is 2.5xy milligrams.

Compared with current powder supply system with a plurality of power sources to cooperate with powder feeding, the powder supply system 100 of the embodiments realize powder supply through a transmission structure, reducing the cost of powder supply, and can control the powder supply amount by controlling the movement of the second stock bin 2, to achieve the precise control of the powder supply amount.

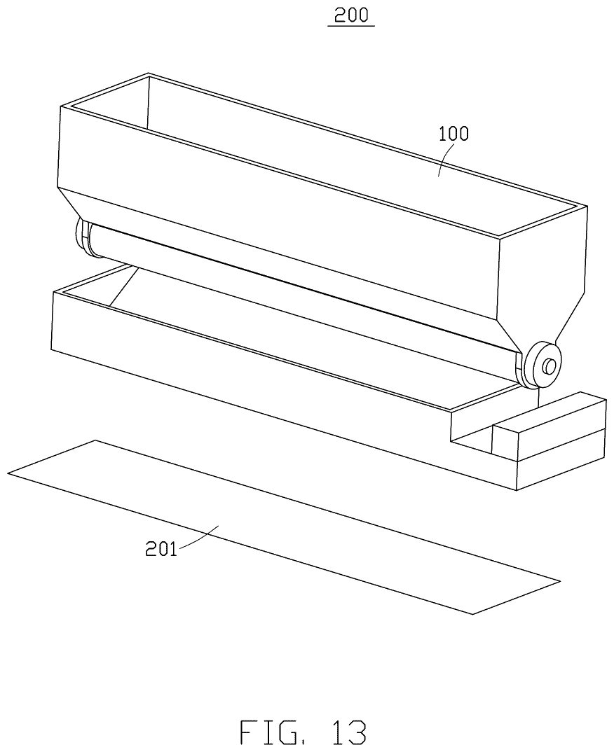

In one embodiment, referring to FIG. 13, illustrating one exemplary embodiment of the 3D printer 200. The 3D printer 200 may include the powder supply system 100 and the platform 201.

The 3D printer 200 may be a metal binder jetting (MBJ) 3D printer, a selective laser melting (SLM) 3D printer, a selective laser sintering (SLS) 3D printers with upper powder supply system, or a 3D printer for printing sand molds. The embodiments do not limit the type of the 3D printer.

If the powder supply system 100 is applied to the 3D printer 200, the second stock bin 2 may also be called as a mobile applicator and a powder spreader.

The second stock bin 2 can be moved across the platform 201 of the 3D printer 200 to tile powders on the platform 201.

In one embodiments, the 3D printer 200 may also include a powder roller 8, the powder roller 8 is arranged at the platform 201, the powder roller 8 is contacted and connected with an outer side wall of the second stock bin 2, and the powder roller 8 is configured to tile powders on the platform 201 under a driving of the second stock bin 2.

The embodiments can reduce the power source of the powder supply system 100 of the 3D printer 200, the cost of the 3D printer 200 can be reduced, and realizing the precise control of the powder supply amount, the powders can be evenly tiled on the platform 201 of the 3D printer 200, to improve a printing effect and a printing success rate.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A powder supply system comprising:
a first stock bin configured to store powders and comprising an outlet;
a driven member arranged at the outlet of the first stock bin, the driven member comprising a powder holding area configured for receiving the powders discharged from the outlet of the first stock bin;
a driving medium drivingly connected with the driven member; and
a second stock bin,
wherein the outlet of the first stock bin is arranged opposite to an inlet of the second stock bin, and the second stock bin is configured to drive the driving medium to contact the driven member when the second stock bin is moved to a discharge range corresponding to the outlet of the first stock bin, and the driven medium drives the driven member to discharge the powders in the powder holding area into the second stock bin.

2. The powder supply system of claim 1, wherein the driven member further comprises a gear and a roller, the gear are coaxially connected with the roller, the roller is arranged at the outlet of the first stock bin, and the roller is rotatable to block the outlet of the first stock bin, the gear is configured to drive the roller to roll, and the powder holding area is arranged at the roller; and
the driving medium comprises a driving rack, the driving rack is arranged at the second stock bin, the driving rack is configured to mesh with the gear to drive the roller to roll when the second stock bin moves to the discharge range corresponding to the outlet of the first stock bin, and the powders in the powder holding area arranged at the roller is discharged into the second stock bin.

3. The powder supply system of claim 1, wherein the driven member further comprises a powder holding box, the powder holding area is arranged in an inner cavity of the powder holding box, the powder holding box further comprises a first movable sidewall and a second movable sidewall, and the first movable sidewall is arranged opposite to the second movable sidewall;
the driving medium comprises a pushing member, a first end of the pushing member is arranged opposite to the first movable sidewall, a second end of the pushing member is correspondingly arranged to the second stock bin, the pushing member is configured to push the first movable sidewall to move within the inner cavity of the powder holding box to move powders in the inner cavity of the powder holding box, the second movable sidewall is pushed to move exterior the inner cavity of the powder holding box when the powders in the inner cavity of the powder holding box is pushed to move by the first movable sidewall; and
the second stock bin is configured to contact the second end of the pushing member to drive the pushing member to move when the second stock bin moves to the discharge range corresponding to the outlet of the first stock bin.

4. The powder supply system of claim 3 further comprising:
a limiting member slidably connected with the pushing member, wherein the limiting member is configured to limit movements of the pushing member within a fixed path.

5. The powder supply system of claim 3, wherein the driving medium further comprises a reset member, the reset member is connected with the pushing member, and the reset member is configured to restore a position of the pushing member when the second stock bin is not at the second end of the pushing member.

6. The powder supply system of claim 5, wherein the reset member comprises a reset gear, a rotating shaft, and a torsion spring, a spring body of the torsion spring is co-axial with the reset gear, and the spring body of the torsion spring is installed at the rotating shaft, an end of the torsion spring is fixed on the rotating shaft, another end of the torsion spring is fixed on the reset gear, and the reset gear is meshed and linked with the pushing member.

7. The powder supply system of claim 1 further comprising:
a powder supply control device communicated with the second stock bin, wherein the powder supply control device is configured to acquire information of powder supply demands, and control the second stock bin to move based on the acquired information of the powder supply demands.

8. The powder supply system of claim 7, wherein the powder supply control device is further configured to obtain information of a total powder holding amount of the powder holding area, determine current motion information of the driven member according to current motion information of the second stock bin, and determine a current powder supply amount of the powder supply system according to the current motion information of the driven member and the information of the total powder holding amount of the powder holding area.

9. A three-dimensional printer comprising:
a platform;
a powder roller; and
a powder supply system comprising:
a first stock bin configured to store powders and comprising an outlet;
a driven member arranged at the outlet of the first stock bin, the driven member comprising a powder holding area configured for receiving the powders discharged from the outlet of the first stock bin;
a driving medium drivingly connected with the driven member; and
a second stock bin;
wherein the outlet of the first stock bin is arranged opposite to an inlet of the second stock bin, and the second stock bin is configured to drive the driving medium to contact the driven member when the second stock bin is moved to a discharge range corresponding to the outlet of the first stock bin, and the driven medium drives driven member to discharge the powders in the powder holding area into the second stock bin;
the powder roller is arranged at the platform, the powder roller is contacted and connected with an outer sidewall of the second stock bin, and the powder roller is configured to tile powders on the platform under a driving of the second stock bin.

10. The three-dimensional printer of claim 9, wherein the driven member further comprises a gear and a roller, the gear are coaxially connected with the roller, the roller is arranged at the outlet of the first stock bin, and the roller is rotatable to block the outlet of the first stock bin, the gear is configured to drive the roller to roll, and the powder holding area is arranged at the roller; and
the driving medium comprises a driving rack, the driving rack is arranged at the second stock bin, the driving rack is configured to mesh with the gear to drive the roller to roll when the second stock bin moves to the discharge range corresponding to the outlet of the first stock bin, and the powders in the powder holding area arranged at the roller is discharged into the second stock bin.

11. The three-dimensional printer of claim 9, wherein the driven member further comprises a powder holding box, the powder holding area is arranged in an inner cavity of the powder holding box, the powder holding box further comprises a first movable sidewall and a second movable sidewall, and the first movable sidewall is arranged opposite to the second movable sidewall;
the driving medium comprises a pushing member, a first end of the pushing member is arranged opposite to the first movable sidewall, a second end of the pushing member is correspondingly arranged to the second stock bin, the pushing member is configured to push the first movable sidewall to move within the inner cavity of the powder holding box to move powders in the inner cavity of the powder holding box, the second movable sidewall is pushed to move exterior the inner cavity of the powder holding box when the powders in the inner cavity of the powder holding box is pushed to move by the first movable sidewall; and
the second stock bin is configured to contact the second end of the pushing member to drive the pushing member to move when the second stock bin moves to the discharge range corresponding to the outlet of the first stock bin.

12. The three-dimensional printer of claim 11, wherein the powder supply system further comprises:
a limiting member slidably connected with the pushing member, wherein the limiting member is configured to limit movements of the pushing member within a fixed path.

13. The three-dimensional printer of claim 11, wherein the driving medium further comprises a reset member, the reset member is connected with the pushing member, and the reset member is configured to restore a position of the pushing member when the second stock bin is not at the second end of the pushing member.

14. The three-dimensional printer of claim 13, wherein the reset member comprises a reset gear, a rotating shaft, and a torsion spring, a spring body of the torsion spring is co-axial with the reset gear, and the spring body of the torsion spring is installed at the rotating shaft, an end of the torsion spring is fixed on the rotating shaft, an other end of the torsion spring is fixed on the reset gear, and the reset gear is meshed and linked with the pushing member.

15. The three-dimensional printer of claim 9, wherein the powder supply system further comprises:
a powder supply control device communicated with the second stock bin, wherein the powder supply control device is configured to acquire information of powder supply demands, and control the second stock bin to move based on the acquired information of the powder supply demands.

16. The three-dimensional printer of claim 15, wherein the powder supply control device is further configured to obtain information of a total powder holding amount of the powder holding area, determine current motion information of the driven member according to current motion information of the second stock bin, and determine a current powder supply amount of the powder supply system according to the current motion information of the driven member and the information of the total powder holding amount of the powder holding area.
